(19) United States
(12) Patent Application Publication
(10) Pub. No.: US 2010/0293726 A1
(43) Pub. Date: Nov. 25, 2010

(54) Dye stick

(76) Inventor: Leonard Glover, Brooklyn, NY (US)

Correspondence Address: RUTH EURE, 4795 EDISON AVENUE, BOULDER, CO, 80301, US

(21) Appl. No.: 12/800,234

(22) Filed: May 10, 2010

Related U.S. Application Data
(60) Provisional application No. 61/216,275, filed on May 15, 2009.

(51) Int. Cl. B43K 8/00; D06P 1/00

(52) U.S. Cl. 8/636; 401/196

(57) ABSTRACT

The present invention provides a dye stick useful for spot dying clothing, upholstery or other fabric articles to effectively remove unwanted spots, stains or discoloration. Further, the present invention provides a dye stick useful for spot dying fabric wherein the intensity of the color can be adjusted to match the fabric to be dyed.

### CLAIM OF PRIORITY

This patent application claims priority under 35 USC 119(e) (1) from U.S. Provisional Patent Application Ser. No. 61/216,275 filed May 15, 2009, of common inventorship herewith entitled, “Dye Stick”

### FIELD OF THE INVENTION

The present invention pertains to the field of fabric dyes, and more specifically to the field of fabric dye application.

### BACKGROUND OF THE INVENTION

The prior art has put forth several designs and methods for the application of dye to fabric. Among these are:

U.S. Pat. No. 1,337,009 to Foley which discloses a dye stick for inclusion in a vat of dye for dying yarn, cloth or other material. The dye stick of this reference is suspended by its ends into the vat.

U.S. Pat. No. 2,835,604 to Aronberg discloses a dye stick and process of making it. The dye stick of this reference describes dye compositions and configurations for use by children similar to crayons or chalk that function in a manner akin to paints.

U.S. Pat. No. 5,879,414 to Milazzo describes hydrous hair dyeing stick compositions useful for coloring hair.

None of these references describe the present invention.

### SUMMARY OF THE INVENTION

It is an object of the present invention to provide a dye stick useful for spot dying clothing, upholstery or other fabric articles to effectively remove unwanted spots, stains or discoloration.

It is a further object of the present invention to provide a dye stick useful for spot dying fabric wherein the intensity of the color can be adjusted to match the fabric to be dyed.

### BRIEF DESCRIPTION OF THE DRAWINGS

FIG. 1 shows the dye stick of the present invention with the cap on and a second illustration showing the dye stick of the present invention with the cap off.

FIG. 2 shows a shirt having a spot thereon.

FIG. 3 shows the application of the dye stick to the spot.

FIG. 4 shows the shirt having the spot effectively removed by application of the dye stick.

FIG. 5 shows a diagram indicating the function of pressing, releasing the measured amount and clicker returning to its original position.

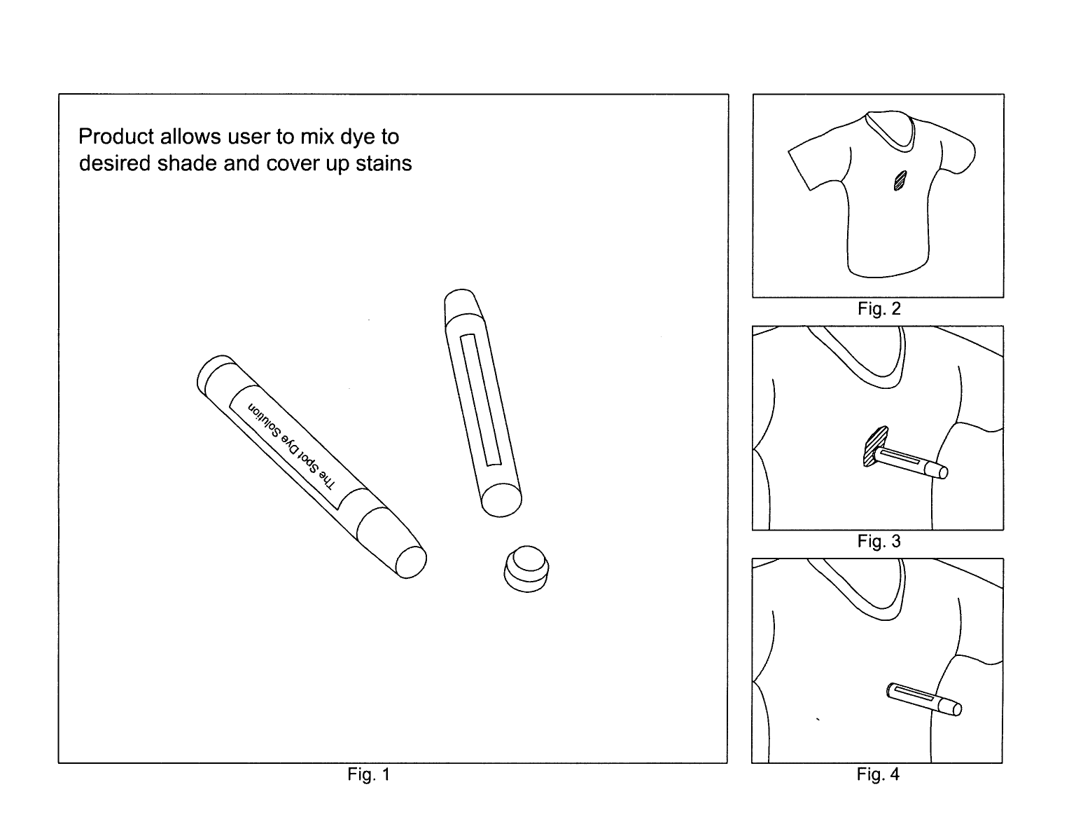

### DETAILED DESCRIPTION OF THE INVENTION

Each of us has highly valued, favorite articles of clothing, and upholstered seats in our car and upholstered furniture in our home. All of these articles can be easily ruined by a single spot or stain. Until now, our only recourse to such a situation would be to have the article dyed or to replace it. The present invention provides a far better, more economical alternative, and could thus make the lives of millions of consumers a little better. The present invention provides an inexpensive, practical means of spot-dying stained or spotted clothing or upholstery, aqnd is hereinafter referred to as “the Dye Stick.” The Dye Stick is a marker-type spot applicator for textile dyes, the intent of which is to enable consumers to quickly and easily spot-dye affected fabric clothing and textile upholstery.

Manufactured by the Chemicals and Chemical Preparations industry, Standard Industrial Code 2899, the Dye Stick is a plastic cylindrical vial or tube, 5 to 6 inches in length and ¾-inch in diameter. The top end of the Dye Stick is sealed with a screw-on cap. The bottom end of the Dye Stick terminates in a chisel-tip felt marker tip, and this applicator tip is covered by a snap-on removable plastic cap.

The Dye Stick contains a volume of concentrated household fabric dye, and would be produced in a wide variety of colors. These colors would not, however, attempt to match the entire range of hues represented by all existing clothing and upholstery.

An alternative embodiment provides a means for matching the Dye Stick to the article being dyed. The top cap of the Dye Stick, as mentioned, would be a threaded, screw-on cap. To match the color of the Dye Stick to the article being dyed, the user removes this cap and then adds small volumes of water to the dye in the Dye Stick. The sides of the Dye Stick would be calibrated with levels, such that, having purchased the Dye Stick in a basic color, the user would then add water to the appropriate level to match the color of the article being spot-dyed. A small volume of water would render a dark hue of the dye's color; a medium volume of added water would result in a medium-dark dye; and a high level of water would result in a light hue of the color.

The dyes in the various colors of the Dye Stick line are colorfast, and will not run, bleed, or be washed away in machine washing of the garment. The Dye Stick can be intended to be a single-use, disposable product, and would lend itself to display with the various colors of the Dye Stick perhaps arranged in a rainbow or spectrum pattern of colors.

The Dye Stick, a marker-type spot applicator for fabric dyes in a wide variety of colors, presents a number of distinct and significant benefits and advantages. Foremost, the Dye Stick product line enables any consumer to match the color, and dye back to its original appearance, virtually any article of clothing, fabric, or upholstery. Spots and stains on fabrics are an inevitable fact of life, and prior to the invention of the Dye Stick, such spots and stains were either impossible to remove, or too costly to deal with. Now, with the Dye Stick any consumer can quickly select a Dye Stick in the appropriate color to match the article being dyed, prepare the Stick with the simple addition of an appropriate volume of water, and then spot-dye the article back to its original appearance: no mess, no costly dying of the entire article or garment, and no trouble matching the color.

In an alternative embodiment, the dye stick comprises a compartment at the top of the dye stick that stores a solution of lightener, that is available if needed to produce a lighter hue. In this case, the user presses the retractable clicker and a measured amount of lightener will enter the dye stick and the user shakes the dye stick to mix the dye and the lightener to match the desired color of the fabric being dyed.

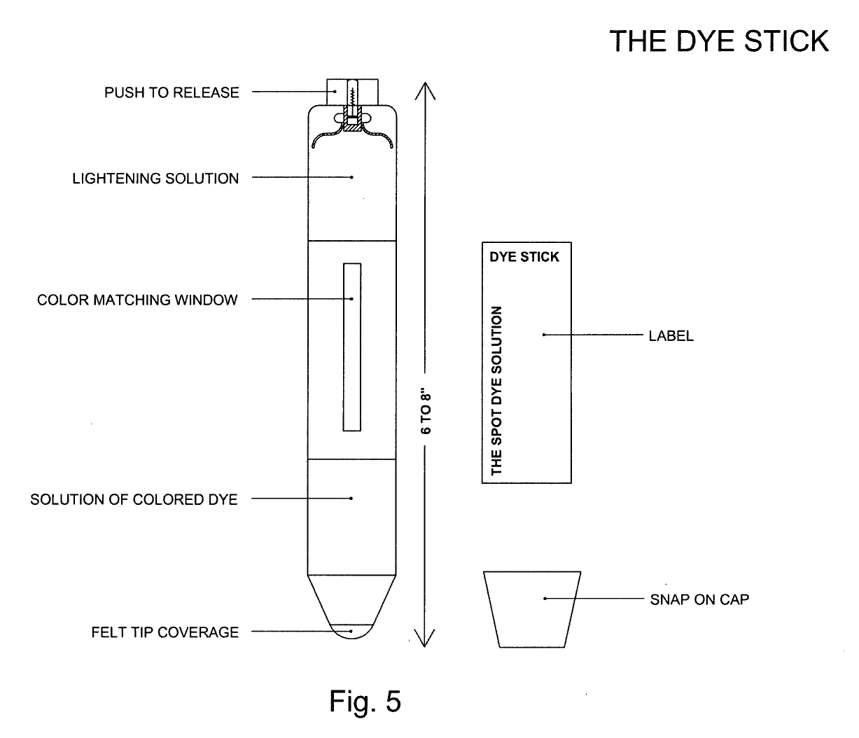

FIG. 5 shows a diagram indicating the function of pressing, releasing the measured amount and clicker returning to its original position. This operation is the only intricate part of the dye stick.

The Dye Stick enables consumers to reclaim articles of clothing, automobile upholstery, and other fabric or textile articles which in the past would have been irretrievably ruined by a stain or spot. Using the Dye Stick would be far easier and will appeal to all consumers, regardless of their experience or expertise in the arts of sewing or dying, as no experience is necessary. Thus, this cleverly conceived invention will serve to greatly extend the life of clothing and other fabrics, and thereby stretch the always-precious consumer dollar.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A dye stick, comprising a plastic cylindrical vial or tube having a top end and a bottom end, which tube is about 5 to 6 inches in length and about ¾-inch in diameter, wherein the top end of the dye stick is sealed with a screw-on cap, and wherein the bottom end of the dye stick terminates in a chisel-tip felt marker tip, which marker tip is covered by a snap-on removable plastic cap.

2. The dye stick of claim 1 wherein the dye stick contains a volume of concentrated household water-soluble fabric dye.

3. The dye stick of claim 2, wherein the sides of the dye stick are calibrated with levels to allow the addition of a specific volume water to control the hue of the dye to match the color of the article being spot-dyed.

4. The dye stick of claim 2 wherein the concentrated household water-soluble dye is colorfast, and will not run, bleed, or be washed away in machine washing of the garment.

5. The dye stick of claim 2 wherein the dye stick is a single-use, disposable product.

6. The dye stick of claim 2, further comprising a compartment at the top of the dye stick for storage of a solution of lightener, that is available if needed to produce a lighter hue.

7. A method of adjusting the color of dye in the dye stick comprising:
a) pressing the retractable clicker to release a measured amount of lightener will enter the dye stick;
b) shaking the dye stick to mix the dye and the lightener to match the desired color of the fabric being dyed.
